(19) United States
(12) Patent Application Publication
(10) Pub. No.: US 2015/0330282 A1
(43) Pub. Date: Nov. 19, 2015

(54) TURBOGENERATOR SYSTEM AND METHOD

(71) Applicant: BOWMAN POWER GROUP LIMITED, Southampton (GB)

(72) Inventors: Stephen Cusworth, Southamptom (GB); Jonathon McGuire, Southamptom (GB); Paul Dowman-Tucker, Southamptom (GB); Shinri Szymko, Southamptom (GB); Toby King, Southamptom (GB)

(21) Appl. No.: 14/651,476

(22) PCT Filed: Dec. 12, 2013
(86) PCT No.: PCT/GB2013/053277

§ 371 Date: Jun. 12, 2015

(30) Foreign Application Priority Data
Dec. 13, 2012 (GB) 1222491.1

(51) Int. Cl. F01N 5/04; F02B 37/00; H02K 7/18; F01D 15/10

(52) U.S. Cl. CPC F01N 5/04; F01D 15/10; F02B 37/005; H02K 7/1823

(57) ABSTRACT

A turbogenerator system for extracting energy from a fluid stream is described. The system comprises a turbogenerator arranged to be driven by the fluid, the turbogenerator comprising a turbogenerator turbine having an inlet for receiving the fluid and an outlet for exhausting the fluid. The turbogenerator further comprises an alternator arranged on an output shaft of the turbogenerator turbine for the conversion of shaft power into electrical power. A control arrangement is provided for controlling operation of the turbogenerator in dependence upon operating conditions for the turbogenerator system.

This invention concerns a turbogenerator system to extract energy from a gas stream, and a method for extracting energy from a gas stream.

The invention finds particular application in a turbogenerator system and method to extract energy from a gas stream such as: the exhaust from a compression ignition diesel engine, exhaust from a spark ignition gas engine, steam, an organic rankine fluid or pressurised gas. For example, the system and method of the invention may be employed for recovering exhaust energy from fluid in an exhaust conduit of a reciprocating engine.

Prior art turbogenerator systems have limitations in their ability to maximise the usefulness and efficiency of current turbogenerator exhaust energy recovery systems, as there is insufficient control of the exhaust flow characteristics in such systems.

The present invention makes use of valves and/or other control methods in a turbogenerator system and method to address these limitations.

According to an aspect of the invention, a turbogenerator system for extracting energy from a fluid stream comprises a turbogenerator arranged to be driven by the fluid, the turbogenerator comprising a turbogenerator turbine having an inlet for receiving the fluid and an outlet for exhausting the fluid, the turbogenerator further comprising an alternator arranged on an output shaft of the turbogenerator turbine for the conversion of shaft power into electrical power, and a control arrangement for controlling operation of the turbogenerator in dependence upon operating conditions for the turbogenerator system.

According to another aspect of the invention, a method for controlling a turbogenerator for extracting energy from a fluid stream comprises driving a turbogenerator with the fluid, the turbogenerator comprising a turbogenerator turbine having an inlet for receiving the fluid and an outlet for exhausting the fluid, employing an alternator arranged on an output shaft of the turbogenerator turbine for the conversion of shaft power into electrical power, and controlling operation of the turbogenerator in dependence upon operating conditions.

Preferably, the invention is employed for recovering exhaust energy from fluid in an exhaust conduit of a reciprocating engine. In this instance, the invention may further comprise a turbocharger having a turbocharger turbine arranged in fluid communication with the exhaust conduit for carrying the engine exhaust stream to be driven by fluid in the exhaust conduit, and the turbogenerator may be arranged in a series configuration or in a parallel configuration with the turbocharger.

The control system may comprise a permutation of one or more valves. For example, the permutation may be selected to be one or a combination of the following: a turbogenerator regulating valve, a turbogenerator isolating valve, a turbocharger waste-gate valve and an overall system waste-gate valve. In each case, the respective valve may be either manual or automatic, and either an on/off valve or a modulating valve.

The invention will now be described further, by way of example, with reference to the accompanying drawings in which:

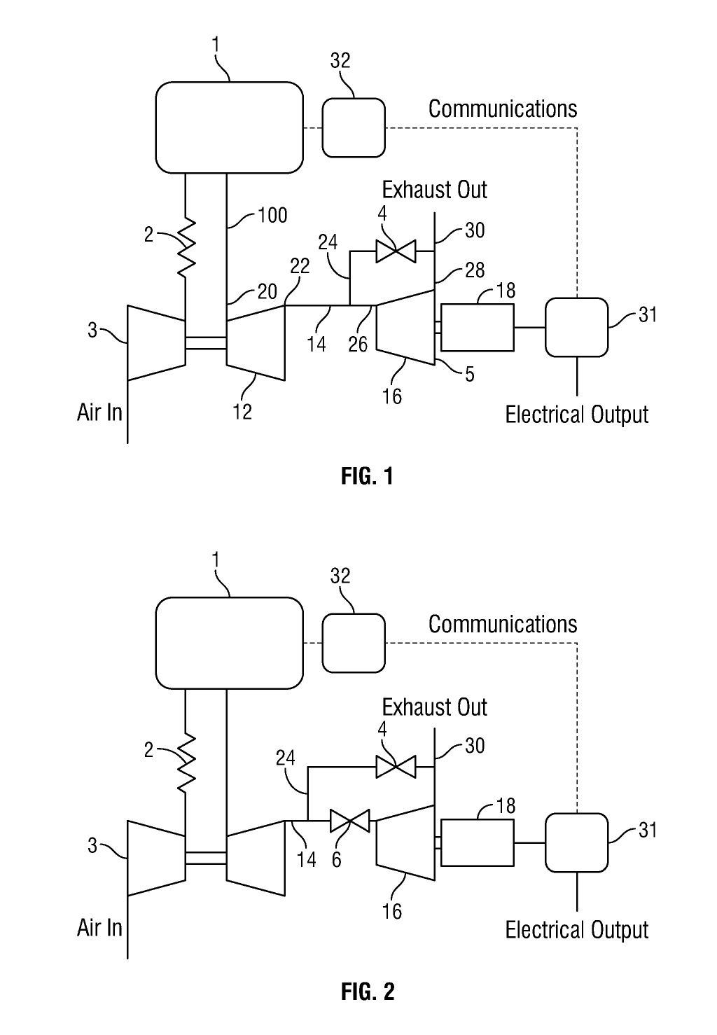

FIG. 1 is a schematic of a turbogenerator system in accordance with a first embodiment of the invention, in which the turbogenerator is in a series configuration and has a turbogenerator regulator valve;

FIG. 2 is a schematic of a second embodiment of the turbogenerator system similar to that of FIG. 1 and having a turbogenerator regulator valve and a turbogenerator isolator valve;

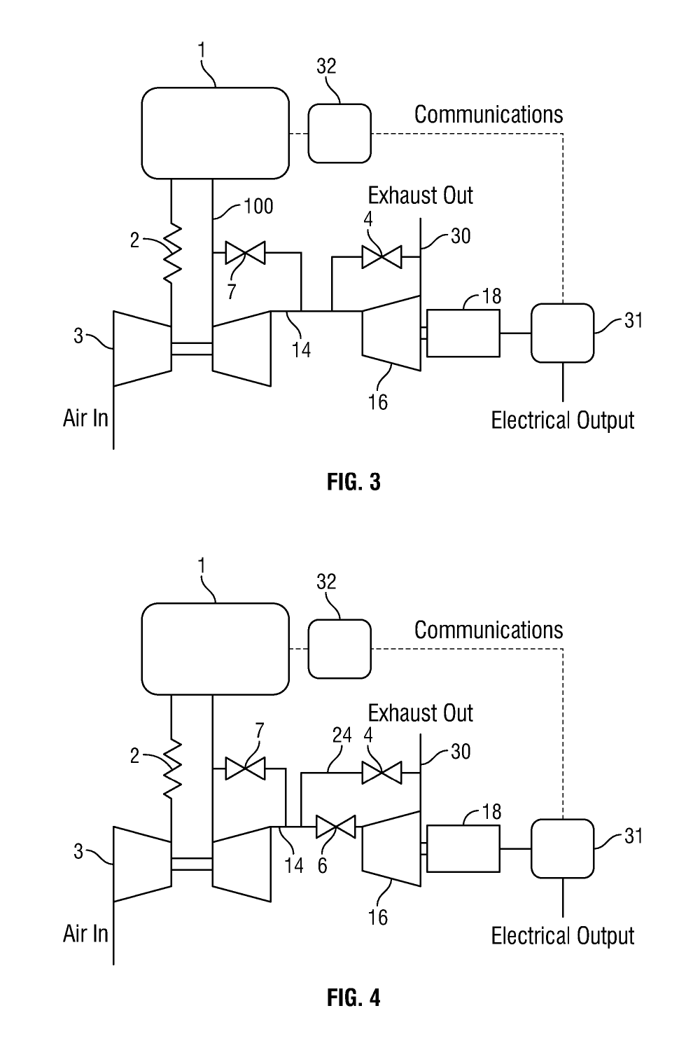

FIG. 3 is a schematic of a third embodiment of the turbogenerator system similar to that of FIG. 1 and having a turbocharger waste-gate valve and a turbogenerator regulator valve;

FIG. 4 is a schematic of a fourth embodiment of the turbogenerator system similar to that of FIG. 1 and having a turbocharger waste-gate valve, a turbogenerator regulator valve and a turbogenerator isolator valve;

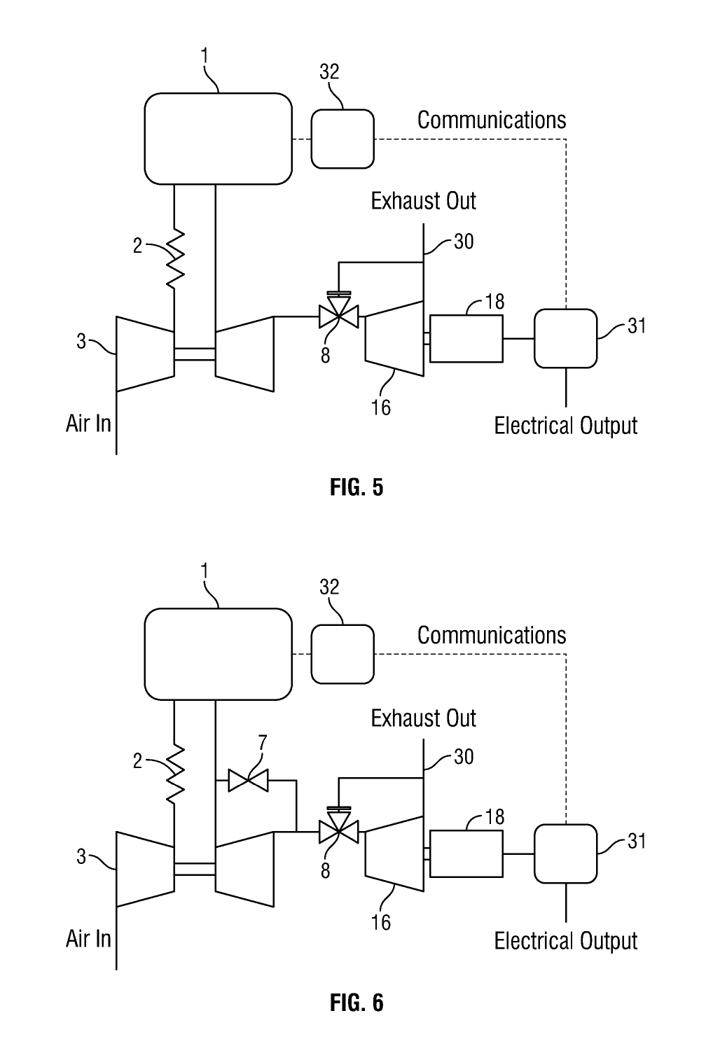

FIG. 5 is a schematic of a fifth embodiment of the turbogenerator system similar to that of FIG. 1 and having a three-way turbogenerator regulator valve;

FIG. 6 is a schematic of a sixth embodiment of the turbogenerator system similar to that of FIG. 1 and having a turbocharger waste-gate valve and a three way turbogenerator regulator valve;

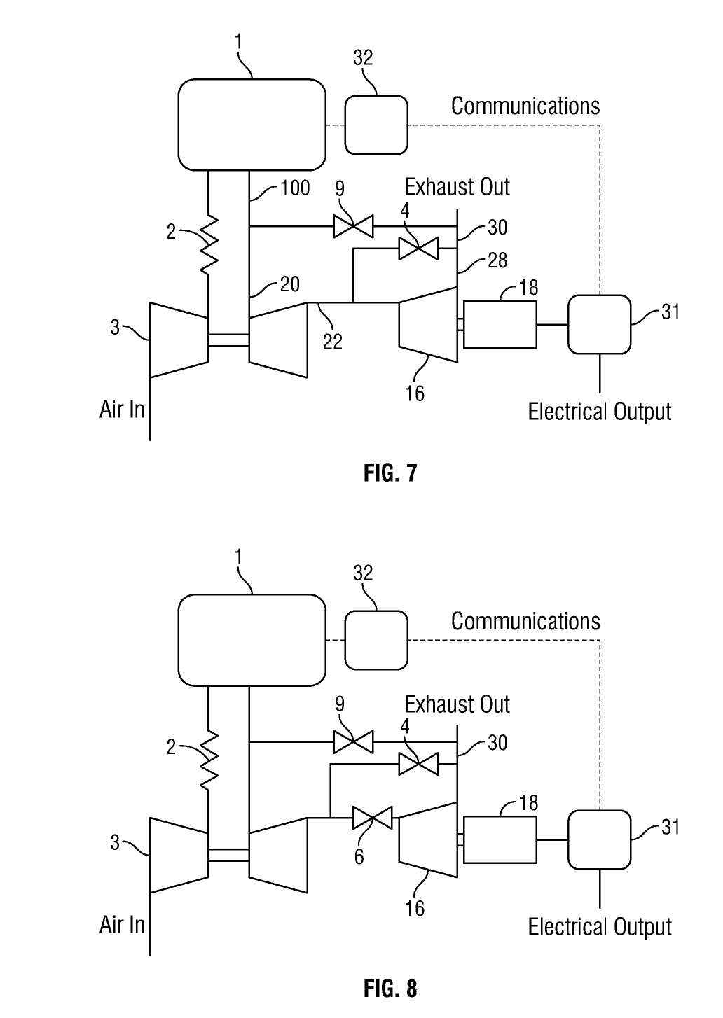

FIG. 7 is a schematic of a seventh embodiment of the turbogenerator system similar to that of FIG. 1 and having a system waste-gate valve and a turbogenerator regulator valve;

FIG. 8 is a schematic of an eight embodiment of the turbogenerator system similar to that of FIG. 1 and having a system waste-gate valve, a turbogenerator regulator valve and a turbogenerator isolator valve;

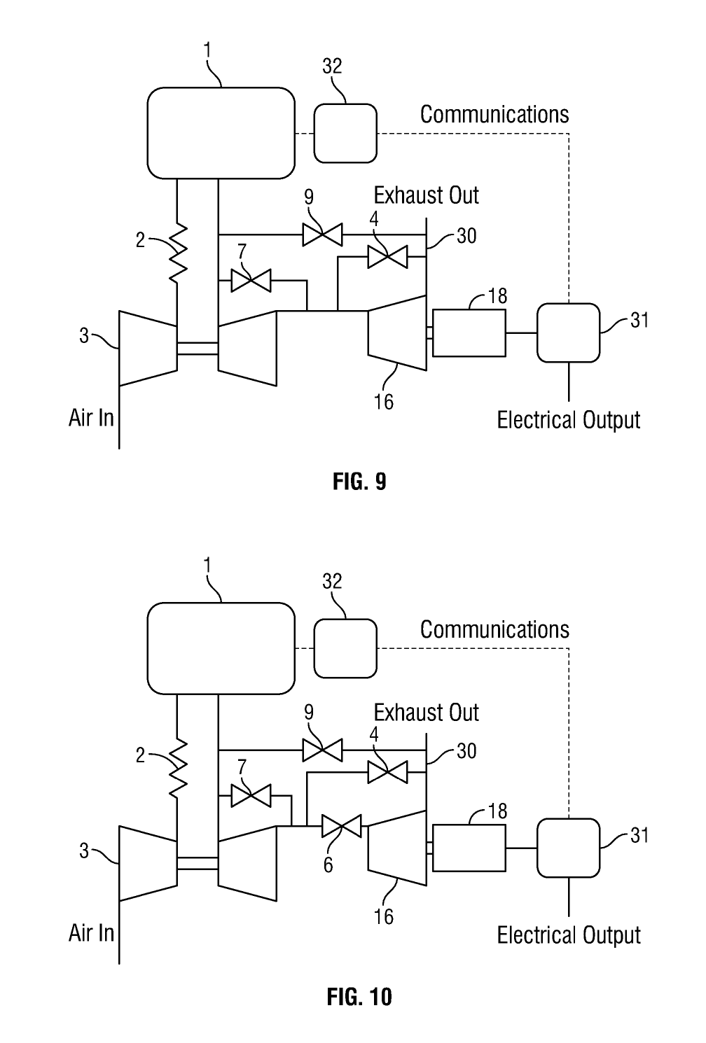

FIG. 9 is a schematic of a ninth embodiment of the turbogenerator system similar to that of FIG. 1 and having a system waste-gate valve, a turbocharger waste-gate valve and a turbogenerator regulator valve;

FIG. 10 is a schematic of a tenth embodiment of the turbogenerator system similar to that of FIG. 1 and having a system waste-gate valve, a turbocharger waste-gate valve, a turbogenerator regulator valve and a turbogenerator isolator valve;

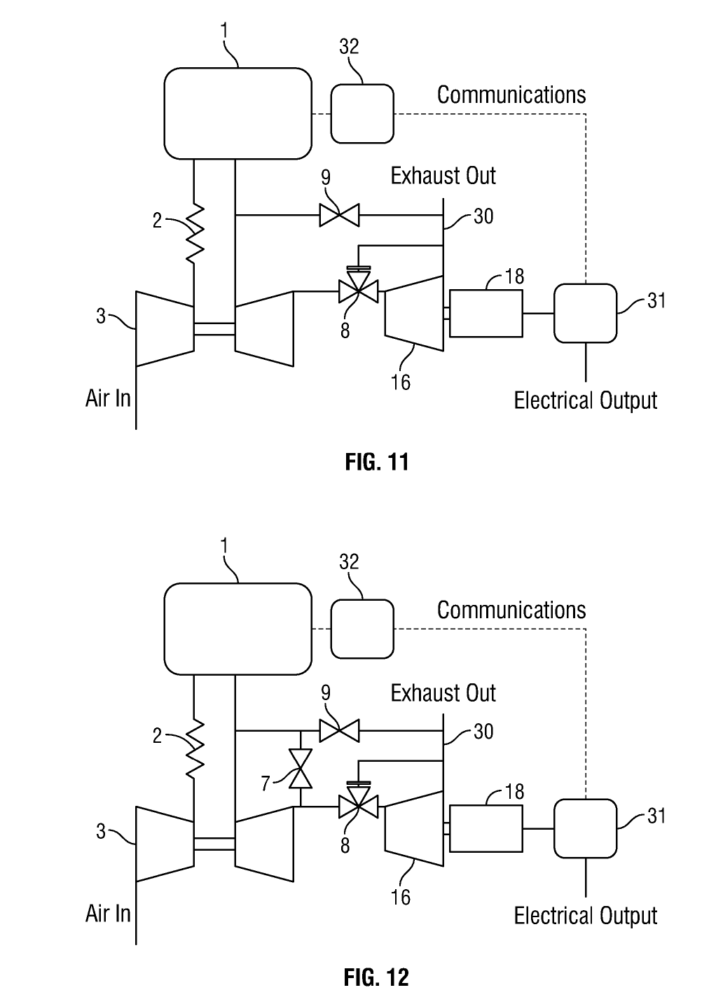

FIG. 11 is a schematic of an eleventh embodiment of the turbogenerator system similar to that of FIG. 1 and having a system waste-gate valve and a three-way turbogenerator regulator valve;

FIG. 12 is a schematic of a twelfth embodiment of the turbogenerator system similar to that of FIG. 1 and having a system waste-gate valve, a turbocharger waste-gate valve and a three-way turbogenerator regulator valve;

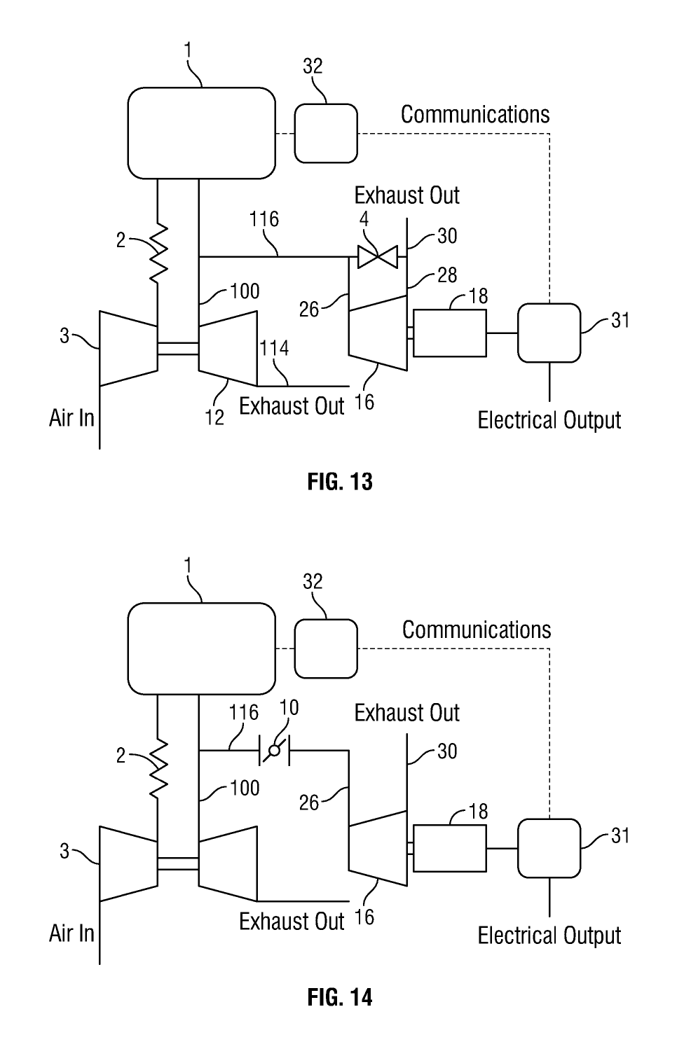

FIG. 13 is a schematic of a thirteenth embodiment of the turbogenerator system, in which the turbogenerator is in a parallel configuration and has a turbogenerator regulator valve;

FIG. 14 is a schematic of a fourteenth embodiment of the turbogenerator system similar to that of FIG. 13 and having a turbocharger waste-gate throttle valve only;

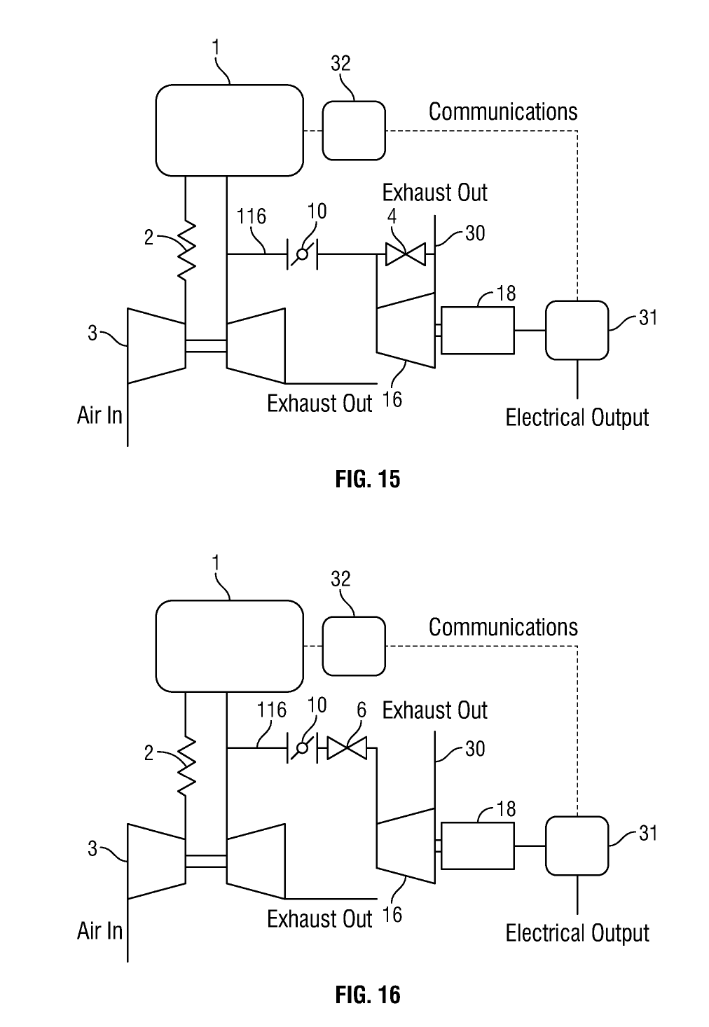

FIG. 15 is a schematic of a fifteenth embodiment of the turbogenerator system similar to that of FIG. 13 and having a turbocharger waste-gate throttle valve and a turbogenerator regulator valve;

FIG. 16 is a schematic of a sixteenth embodiment of the turbogenerator system similar to that of FIG. 13 and having a turbocharger waste-gate throttle valve and a turbogenerator isolator valve;

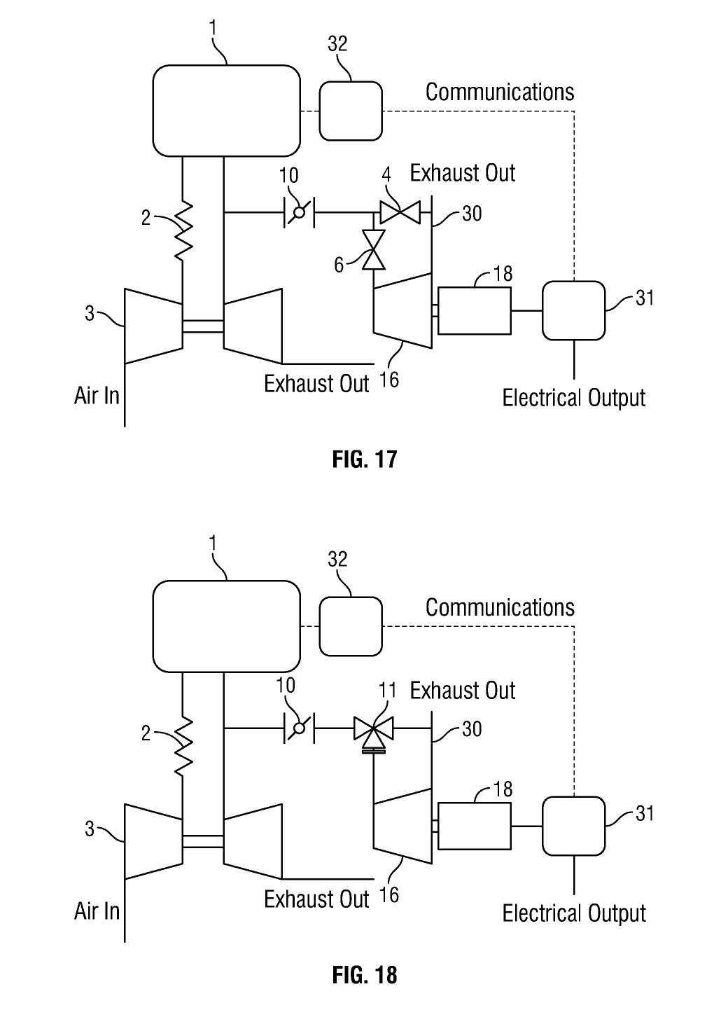

FIG. 17 is a schematic of a seventeenth embodiment of the turbogenerator system similar to that of FIG. 13 and having a turbocharger waste-gate throttle valve, a turbogenerator regulator valve and a turbogenerator isolator valve;

FIG. 18 is a schematic of a processor for the turbogenerator system according to one of FIGS. 1 to 12 having the turbogenerator in a series configuration, showing the control events processed by the processor; and

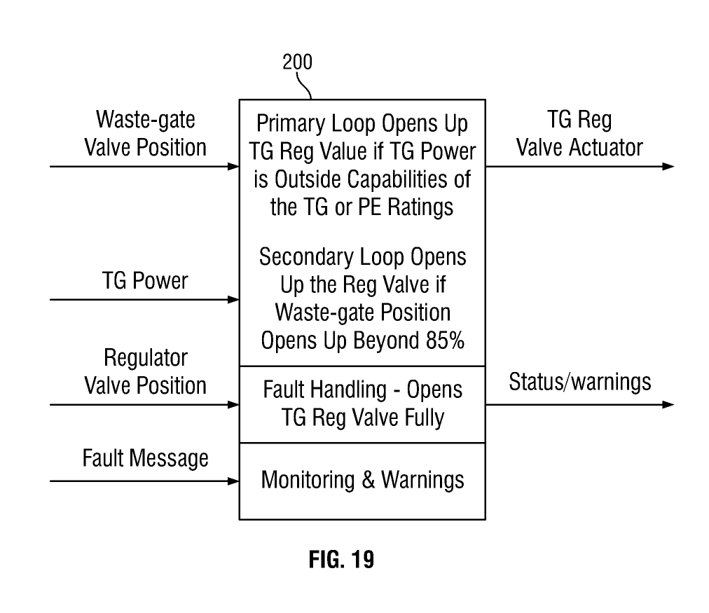

FIG. 19 is a schematic flow diagram of the steps taking place in a processor in the turbogenerator system according to one of FIGS. 13 to 18 in the parallel configuration.

Referring initially to FIGS. 1 to 12, these show a schematic of a turbogenerator system in a series configuration having various permutations for a control valve configuration. The basic turbogenerator system will be described first.

As shown, a reciprocating engine 1, which may be a diesel or spark ignition reciprocating engine, receives incoming air from a turbocharger 3 by way of a charge air cooler 2. The engine 1 has an exhaust conduit 100 which exhausts into an inlet 20 of a turbine 12 of the turbocharger 3. An outlet 22 of the turbine 12 exhausts into a turbine exhaust conduit 14, which is fluidly connected to a turbogenerator 5, connected in series with the turbocharger 3. The turbogenerator 5 comprises a turbine 16, and an alternator 18 arranged on an output shaft of the turbine 16 for the conversion of shaft power into electrical power. The alternator 18 is connected to a power converter 31, which supplies an electrical output, as shown, and which is in communication with an engine control unit 32 described below.

The turbine exhaust conduit 14 exhausts into an inlet 26 of the turbine 16, and an outlet 28 of the turbine 16 exhausts into an exhaust conduit 30 for exhausting to the atmosphere. The turbogenerator 5 is thus connected in a series configuration such that the exhaust gas from the engine 1 passes through the turbocharger turbine 12 first and then through the turbogenerator turbine 16 next.

These features are common to all of the embodiments of FIGS. 1 to 12 and will not be described further, except for explaining the various valve permutations described below.

A first valve permutation is shown in FIG. 1 and comprises a simple turbogenerator regulator valve 4 connected in a branch line 24 between the turbine exhaust conduit 14 and the exhaust conduit 30. The regulator valve 4 thus has one port on the inlet 26 to the turbogenerator 5, and the other port connected to the outlet 28 of the turbogenerator 5. Accordingly, the turbogenerator regulator valve 4 serves to provide a bypass gas-flow from the input 20 of the turbogenerator 5 to the output 22. By controlling the regulator valve 4, the amount of gas-flow bypassing the turbogenerator 5 may be varied to control the power generated by the turbogenerator 5. The valve 4 may be either manual or automatic, and depending on the desired control may be an on-off valve or a modulating valve.

In a second valve permutation shown in FIG. 2, the turbogenerator regulator valve 4 is supplemented by a turbogenerator isolator valve 6 provided in the turbine exhaust conduit 14 downstream of the branch 24 leading to the turbogenerator regulator valve 4. The isolator valve 6 is thus connected immediately upstream of the inlet 20 of the turbogenerator 5 and may be shut down to allow the turbogenerator 5 to be fully bypassed in the event that a fault in, or the need for maintenance of, the turbogenerator 5 arises. By shutting down the turbogenerator 5 in these circumstances, continued operation of the engine 1 remains possible. The valve 6 may be either manual or automatic.

In a third valve permutation, shown in FIG. 3, a turbocharge waste-gate valve 7 is connected in a branch line 32 between the exhaust conduit 100 of the reciprocating engine 1 and the turbine exhaust conduit 14. The turbocharger waste-gate valve 7 may be an on-off valve or a modulating valve and may be manual or automatic. By regulating the valve 7, the main engine air to fuel ratio, namely the ratio of air fed into the engine 1 to the fuel being fed into the engine 1, both measured by mass, may be varied, since the pressure across the turbocharger turbine 12 will vary accordingly, increasing or decreasing the speed of the turbocharger 3 and thus the charge air pressure, and correspondingly increasing or decreasing air flow and engine combustion lambda, where lambda is the ratio of the total oxygen fed into an engine divided by the amount of oxygen required for stoichiometric combustion.

The third permutation shown in FIG. 3 also includes the turbogenerator regulator valve 4 as described above.

A fourth valve permutation shown in FIG. 4 comprises all of the turbocharger waste-gate valve 7, the turbogenerator regulator valve 4 and the turbogenerator isolator valve 6 in combination.

A fifth valve permutation is shown in FIG. 5 and comprises a three-way turbogenerator regulator valve 8, which may be either manual or automatic. The three-way regulator valve 8 is connected in the turbine exhaust conduit 14 and the branch line 26 to control both exhaust flow into the inlet 26 of the turbine 16 and bypass flow bypassing the inlet 26 to the outlet 28 of the turbine 16 and directly from the exhaust conduit 14 to the exhaust conduit 30.

A sixth valve permutation is shown in FIG. 6 and comprises a combination of the turbocharger waste-gate valve 7 and the three-way turbogenerator regulator valve 8 both connected as described above.

A seventh valve permutation is shown in FIG. 7 and comprises an overall system waste-gate valve 9 connected between the exhaust conduit 100 from the engine 1 and the turbogenerator exhaust conduit 24 exhausting to atmosphere. The waste-gate valve 9 may be either manual or automatic, and may also be either an on-off valve or a modulating valve according to requirements. Thus, one port of the waste-gate valve 9 is effectively connected to the inlet 20 of the turbocharger turbine 12, and one port is connected to the outlet 28 of the turbogenerator turbine 16. This valve permutation also includes the turbogenerator regulator valve 4 as already described.

An eight valve permutation is shown in FIG. 8, and comprises a combination of the overall system waste-gate valve 9, the turbogenerator valve 4 and the turbogenerator isolator valve 6.

A ninth valve permutation is shown in FIG. 9 and comprises a combination of the overall system waste-gate valve 9, the turbocharger waste-gate valve 7 and the turbogenerator regulator valve 4.

A tenth valve permutation is shown in FIG. 10 and comprises a combination of the overall system waste-gate valve 9, the turbocharger waste-gate valve 7, the turbogenerator regulator valve 4 and the turbogenerator isolator valve 6.

An eleventh valve permutation is shown in FIG. 11 and comprises a combination of the overall system waste-gate valve 9 and the three-way turbogenerator regulator valve 8.

A twelfth valve permutation is shown in FIG. 12 and comprises a combination of the overall system waste-gate valve 9, the turbocharger waste-gate valve 7 and the three-way turbocharger regulator valve 8, as described above.

Turning now to FIGS. 13 to 18, a further turbogenerator system having a different turbogenerator configuration is shown. In these figures, the engine 1 and turbocharger 3 are connected as described above. The alternator 18 of the turbogenerator 5 is connected to the power converter 31, as before, and the power converter is in communication with the engine control unit 32, as before. However, the turbogenerator 5 is connected in a parallel configuration, such that the engine exhaust gas passes either through the turbocharger turbine 12 or through the turbogenerator turbine 16. More especially, the turbine 12 of the turbogenerator 3 exhausts to the atmosphere through a turbine exhaust conduit 114. A branch line 116 leads of the engine exhaust conduit 100 to the inlet 26 of the turbine 16 of the turbogenerator 5. The turbogenerator exhaust conduit 30, leading from the outlet 28 of the turbine 16, exhausts to atmosphere as before.

Such parallel configuration for the turbogenerator 5 is employed in all of the embodiments shown in FIGS. 13 to 18 and will not be described further, except for explanation of further respective valve permutations.

FIG. 13 shows a valve permutation in which a turbogenerator regulator valve 4, as above, is connected between the inlet 26 and the outlet 28 of the turbine 16 around the turbogenerator turbine 16. The turbogenerator regulator valve 4 is thus connected between the branch line 116 and the exhaust conduit 30.

In a further valve permutation shown in FIG. 14, a turbocharger waste-gate valve throttle valve 10 is connected in the branch line 116 from the exhaust conduit 100 to the inlet 26 of the turbogenerator turbine 16. The waste-gate throttle valve 10 thus has one port connected to the inlet 20 of the turbocharger turbine 12 and one port connected to the discharge of the turbocharger turbine 12. The waste-gate throttle valve 10 may be either manual or automatic and may regulate the exhaust gas flow as required.

In a further valve permutation shown in FIG. 15, a combination of the turbocharger waste-gate throttle valve 10 and the turbogenerator regulator valve 4 is provided, connected as described above.

In a further valve permutation shown in FIG. 16, the turbocharger waste-gate throttle valve 10 is combined with a turbogenerator isolator valve 6, as shown. In this instance, both valves are connected in series in the branch line 116, with the turbogenerator isolator valve 6 connected downstream of the turbogenerator waste-gate throttle valve 10.

In a further valve permutation shown in FIG. 17, the turbogenerator regulator valve 4 is added to the combination of the turbocharger waste-gate throttle valve 10 and the turbogenerator isolator valve 6 as shown in FIG. 16. In this instance, the turbogenerator regulator valve 4 is connected to a point 118 between the turbocharger waste-gate throttle valve 10 and the turbogenerator isolator valve 6 and to the exhaust conduit 30.

A further valve permutation is shown in FIG. 18 and comprises the turbocharger waste-gate throttle valve 10 combined with a three-way turbogenerator regulator valve 11, which connects the downstream side of the turbocharger waste-gate throttle valve 10 both to the inlet 26 of the turbine 16 and to the outlet 28 of the turbine 16. The three-way turbogenerator regulator valve 11 may be either manual or automatic as before.

It will be appreciated that an appropriate selection of valve permutation from those described above, together with appropriate control of the valve or valves included therein, opens up the possibility for a very wide range of control variations for the exhaust flow characteristics from the reciprocating engine 1 according to the particular application. Although the various valves may as stated be manually controlled, in a preferred version of the invention, the valve or valves are computer controlled, and a processor 200 for the control of the valve or valves in the series configuration for the turbogenerator 5 is shown in FIG. 19, and may be included in the engine control unit 32.

As shown in FIG. 19, the processor 200 receives inputs from a variety of sensors representing, respectively, waste-gate valve position (if a waste-gate valve is present), turbogenerator power, regulator valve position, and fault monitoring. Depending on these inputs, the processor 200 monitors whether the turbogenerator power is outside the capabilities of either the turbogenerator 5 or power electronics ratings for a power electronics device controlling the turbogenerator 5, and opens up the turbogenerator regulator valve 4 and/or 8 as a primary loop in this event. The processor 200 supplies a control signal to a or a respective valve actuator (not shown) for controlling the turbogenerator regulator valve 4 or 8.

The processor 200 also monitors whether the waste-gate valve position indicates that the waste-gate valve 7 and/or 9, if present, has opened up beyond 85%. In this event, again, the processor 200 sends out an actuating signal to the or the respective the valve actuator for the turbogenerator regulator valve 4 or 8.

In addition, the processor 200 monitors fault messages and warnings, and in the event of a fault opens the turbogenerator regulator valve 4 and/or 8 fully, whilst also issuing a warning signal.

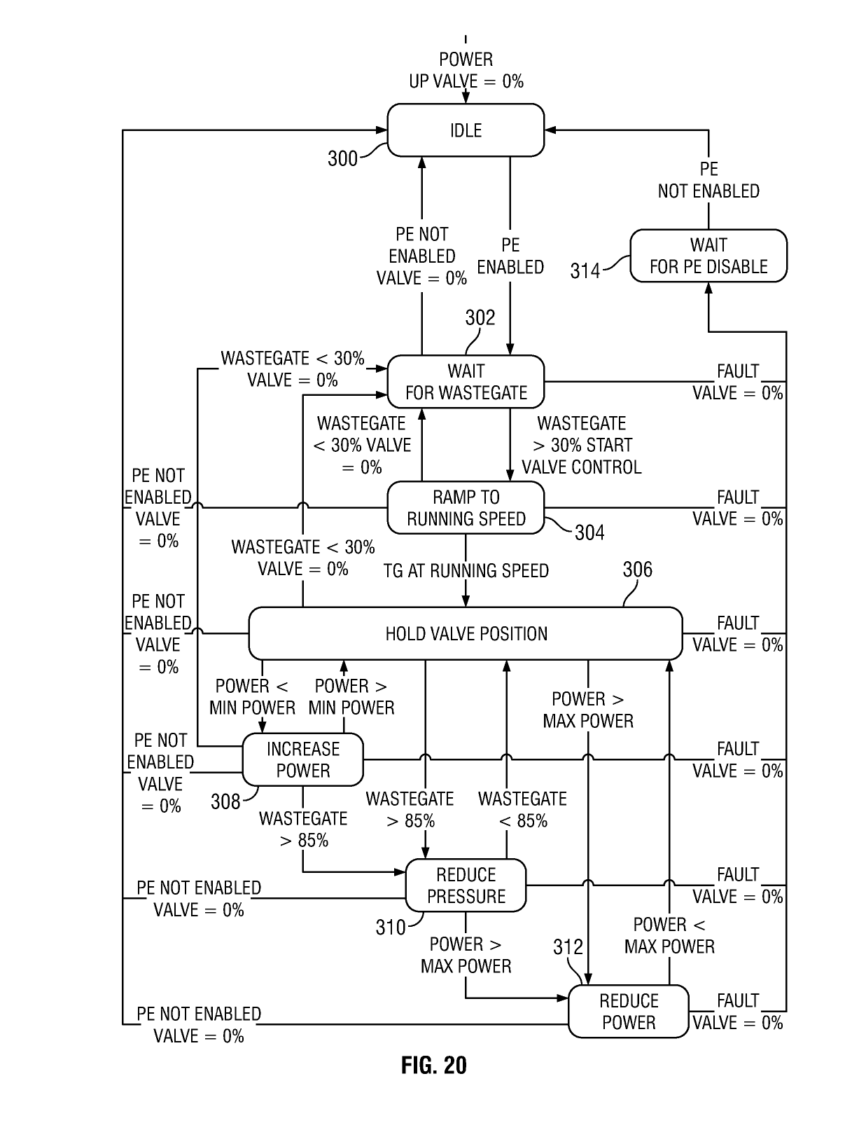

In the case of the parallel configuration for the turbogenerator 5, as shown in FIGS. 13 to 18, again the preferred embodiment features a computer control system for processing and performing the steps as shown in the flow-chart of FIG. 20. AS before, the computer control system may include a processor 200, and may be included in the engine control unit.

As shown in FIG. 20, following power up, the engine 1 is placed in an idle condition in step 300. The processor monitors whether the power electronics have been enabled and advances the process to step 302 when they have been enabled. In step 302, the processor waits for activation of the waste-gate valve 10, if present, and initiates valve control when the waste-gate valve 10 has been opened to at least 30%. In step 304, the processor ramps the turbogenerator 5 up to running speed. When the turbogenerator 5 is at running speed, the processor advances to step 306 and holds the valve positions for the turbogenerator regulator valve 4 and any other valves present.

In the meantime, the processor is monitoring all the valves consistently and initiates feedback signals to increase power if the power developed by the turbogenerator 5 is below the minimum power requirement (step 308 and, to return to holding the valve position (step 306) when the power again exceeds the minimum power; to reduce pressure (step 310) when the waste-gate valve is open greater than 85% and to hold the valve position (step 306) when the waste-gate valve decreases below 85%; and to reduce power (step 312) when the power developed by the turbogenerator 5 exceeds the maximum power and to return to holding the valve position (step 306) once the power has been reduced below the maximum power.

Throughout this process, the processor is also monitoring for faults and when the valve opening for the turbogenerator valve equals 0% sends a fault signal to disable the power electronics in step 314. Once the power electronics are no longer enabled, signals issued in the various steps would revert the engine 1 to the engine idle condition in step 300.

By these means, various control strategies are possible, for example as set out below:

Strategy 1—Control of the Power Developed by the Turbogenerator

This strategy uses the regulator valve 4, 8 or 11 in both the series and the parallel configurations for the turbogenerator 5 to bypass gas flow around the turbogenerator 5, thereby to reduce the power output of the turbogenerator 5. In extreme circumstances, the power output may be reduced to close to zero. In particular, this may be required for certain grid connect regulations (including those specified by the VDE—the largest association for electronic standards in Europe). This strategy may also serve for extending the range of applicability of a particular turbogenerator design.

This strategy:
Allows the power generated by the turbogenerator 5 to be reduced in the event that the grid frequency increases beyond a certain limit
Allows the generated power to be steadily increased after the grid returns to a normal frequency condition.
Allows the power to be reduced so that the power converter 31 can produce adequate kVArs without exceeding its kVA rating.
Allows the turbogenerator 5 to be run at a user specified operating point, which may be set for optimal efficiency and/or power and/or life, for a range of outputs of the engine 1. This allows a single design of turbogenerator to be adapted to the situation, where a range of designs would be required according to the prior art.
Allows greater flexibility in turbogenerator operating range, greater applicability to different prime movers, such as the engine 1, leading to better commercialisation potential.
Allows the turbogenerator 5 to be fully by-passed to allow the prime mover (engine 1) to continue operation if a fault occurs within the turbogenerator and/or if maintenance is required.

Strategy 2—Main Engine Lambda (Air to Fuel Ratio) Control in Series Turbogenerator Configurations

To maintain correct combustion and keep engine emissions within acceptable limits, the air to fuel mixture for the engine 1 needs to be regulated within a limited range by the engine control unit. In particular, for gas engines, this range can be quite small. In addition, during periods where the load demand is changing rapidly, it can be difficult for the engine controller to keep the air to fuel mixture within this range. In these circumstances, the load ramp rate must be reduced or emission limits could be breached and/or the engine could misfire.

To help manage the air to fuel ratio (lambda) when the turbogenerator 5 is connected in the series mode of FIGS. 1 to 12, a control strategy can be used to control the turbogenerator regulator valve 4 or 8, employing the power converter 31 and the engine control unit 32 in conert. If lambda is too low, the turbogenerator regulator valve 4, 8 could be opened to reduce the pressure drop across the turbogenerator/valve combination (5, 4, 8), which would increase the pressure developed across the turbocharger 3, increasing its speed, thereby increasing charge air pressure and therefore air flow to the engine 1.

Unlike most turbogenerators, using the power converter 31, we can choose a turbine speed. For any given mass flow through a turbine, pressure across it changes if the speed is changed (the higher the speed, the higher the pressure drop). Increasing the speed of the turbogenerator 5 will therefore increase the pressure across it. This will decrease the pressure across the output turbine 12 of the turbocharger 3, slowing it down. This will decrease the charge air pressure, decrease air flow to the engine 1 and decrease engine combustion lambda.

Conversely, if the turbogenerator speed is decreased, the pressure drop across the turbogenerator turbine 16 will decrease, increasing the pressure drop across the turbocharger turbine 12, speeding it up, increasing charge air pressure, increasing air mass flow and increasing lambda.

A valve control system can therefore be designed including a processor 200, which operates as follows:
Lambda too low→open turbogenerator regulator valve 4, 8 and decrease turbogenerator speed
Lambda too high→close turbogenerator regulator valve 4, 8 and increase turbogenerator speed

Strategy 3—Exhaust Manifold Pressure Control

If the exhaust manifold pressure rises above a safe limit and the turbogenerator 5 is installed in a series configuration, as shown in FIGS. 1 to 12, the turbogenerator regulator valve 4, 8, could be controlled to open, which would reduce the pressure at the exhaust manifold of the engine 1.

In addition, if the turbogenerator speed is also reduced, the pressure drop across it will decrease the exhaust pressure. A valve control system can therefore be designed to operate as follows:
Pressure too high→open turbogenerator regulator valve 4, 8 and/or decrease turbogenerator speed

Strategy 4—Exhaust Manifold Temperature Control

If the exhaust manifold temperature rises above a safe limit, if the turbogenerator is installed in a series configuration, as shown in FIGS. 1 to 12, the turbogenerator regulator valve 4, 8 could be controlled to open, which would reduce the pressure at the exhaust manifold of the engine 1, leading to reduced exhaust temperatures.

In addition, if the turbogenerator speed is also reduced, the pressure drop across it will decrease the exhaust pressure leading to decreased exhaust manifold temperatures. A valve control system can therefore be designed to operate as follows:
Temperature too high→open turbogenerator regulator valve 4, 8 and/or decrease turbogenerator speed

Strategy 5—Safe Engine Start-Up and Control in Parallel Turbogenerator Configurations

This strategy further elaborates on the description of FIG. 20 above, as to how various valve permutations would be operated when fitted to a turbogenerator system with a parallel configuration (FIGS. 13 to 18). In particular, it describes a safe start up procedure and how it could be used to decrease the pressure drop across the turbogenerator 5/turbogenerator regulator valve 4, 11 combination, increasing the pressure drop across the waste-gate valve 9 of the engine 1, forcing it to close up to maintain exhaust manifold pressure for the engine 1. This could enable the engine's main waste-gate valve 9 to stay within its modulation range, allowing it to control the air flow of the main engine 1 for lambda control.

Further, using a similar characteristic as described in strategy 4, increasing the turbogenerator speed will therefore decrease the gas flow through the turbine 16 of the turbogenerator. This will increase the mass flow through the main turbine 12 of the turbocharger 3, speeding it up. This will increase the charge air pressure, increase air flow to the engine 1, and increase engine combustion lambda. Conversely, if the turbogenerator speed is decreased, the mass flow through the turbine 16 of the turbogenerator will increase, decreasing the mass flow through the turbine 12 of the turbocharger 3, slowing it down, decreasing charge air pressure, decreasing air mass flow and decreasing lambda.

A valve control system can therefore be designed including a processor adapted to perform the steps shown in FIG. 20, which operates as follows:
Lambda too low→close the waste-gate valve 10 of the turbocharger 3, increase turbogenerator speed
Lambda too high→open the waste-gate valve 10, reduce turbogenerator speed

Strategy 6—Allows the Turbogenerator to be Warmed Up Slowly

In some cases, in the case of both series and parallel configurations, there might be an advantage in warming up the turbogenerator 5 more slowly (e.g. to extend its service life). If this were the case, then, when the engine 1 is started, it would be advantageous to open the turbogenerator regulator valve 4, 8, 11, preventing most of the exhaust from the engine 1 from passing through the turbogenerator 5. The valve 4, 8, 11 could then be closed gradually over a period, slowly increasing the temperature of the turbogenerator 5 (and allowing it to produce power).

Valve Design Considerations

The choice of valves for any particular permutation must suit the operating environment and also the need for the system to be fail-safe. Consequently, when implementing the various permutations for the turbogenerator regulator valve 4, 8, 11, the turbogenerator isolator valve 6, and the turbocharger and system waste-gate valves 7, 9, and 10, they must be selected with due regard to the harsh environment and speed of response required. Tests have shown the following to be the most appropriate:

| | | | Fail-safe |
|---|---|---|---|
| | | | condition |
| | Charac- | | (no power or |
| Function | teristics | Valve choice | pressure) |
| On-off TC | Very high | Electronically | Normally closed |
| waste-gate | temperature, | controlled, | |
| | fast response, | pneumatically | |
| | 100% seal | actuated popper | |
| | required | valve | |
| Modulating | Very high | Electronically | Normally closed |
| TC | temperature, | controlled, | |
| waste-gate | slow response, | pneumatically | |
| | good sealing | or electrically | |
| | | actuated butterfly | |
| | | valve | |
| On-off | High | Electronically | Normally open |
| turbogenerator | temperature, | controlled, | |
| regulator | fast response, | pneumatically | |
| valve | 100% sealing | actuated popper | |
| | | valve | |
| Modulating | High | Electronically | Normally open |
| turbogenerator | temperature, | controlled, | |
| regulator | slow response, | pneumatically | |
| valve | good sealing | or electrically | |
| | | actuated butterfly | |
| | | valve | |
| turbogenerator | High | Manual or | Series |
| isolating | temperature, | electrically | configuration - |
| valve | 100% seal | driven | normally open |
| | required | gate valve | Parallel |
| | | | configuration - |
| | | | Normally closed |

In addition, valves should be selected having regard to the need for the prevention of turbocharger overspeed during maintenance etc. When the turbogenerator 5 is taken out of service by opening the turbogenerator regulator valve 4, 8, 11, it is important to provide some way of preventing the turbocharger 3 from spinning too quickly and causing excessive charge air pressure to be delivered to the engine 1.

In one example, the diameter of the turbogenerator valve may be selected to give some backpressure to the engine 1. However, if this is implemented, some pressure will be exerted across the turbogenerator 5, hence the need for some sort of turbogenerator isolation valve 6. Alternatively, the turbocharger waste-gate valve 7 can be opened, spilling some of the exhaust flow from the engine 1 through the waste-gate valve 7, and thereby slowing down the turbocharger 3.

The embodiments of the invention described above may provide various advantages, including:
Regulation of the air to fuel ratio of the combustion mixture for an engine
Controls the power available to the turbogenerator whilst not imposing limitations on the prime mover
Allows a single design of turbogenerator to be used in a wide variety of applications
Enables the user to take a turbogenerator out of service to protect the turbogenerator equipment
Enables the user to take the turbogenerator out of service to enable the engine to continue running
Enables a more optimum match of a turbogenerator to the application both technically and commercially by being able to match at the normal running condition rather than the maximum condition
Allows the use of a smaller or possibly no electrical brake circuit to prevent the turbogenerator from overspeeding when power cannot be exported from the power converter for any reason
Could allow the system to ride through transient problems either with the engine (e.g. caused by poor combustion) or with the utility grid/electrical load
Allows the turbogenerator to be isolated from sources of energy to allow maintenance
Extension of the life of the turbogenerator, by preventing it from being exposed to excessive loads/temperatures
Allows the main engine to ramp up/drop load more quickly

1. A method for recovering exhaust energy from exhaust fluid in an exhaust conduit of a reciprocating engine, comprising driving a turbocharger turbine of a turbocharger by means of the exhaust fluid, driving a turbogenerator turbine of a turbogenerator by means of the exhaust fluid, employing an alternator arranged on an output shaft of the turbogenerator turbine for the conversion of shaft power into electrical power, and controlling operation of the turbogenerator turbine in dependence upon operating conditions within the system, the step of controlling including regulating fluid flow to the turbogenerator turbine by means of at least one valve.

2. A method according to claim 1, in which the step of controlling comprises regulating an amount of fluid flow bypassing an inlet of the turbogenerator turbine.

3. A method according to claim 1 or 2, in which the step of controlling comprises controlling fluid flow into an inlet of the turbogenerator turbine.

4. A method according to claim 1, in which the step of controlling comprises respectively controlling fluid flow into an inlet of the turbogenerator turbine and regulating an amount of fluid flow bypassing the inlet of the turbogenerator turbine.

5. A method according to claim 1 or 2, in which the step of controlling comprises controlling the power developed by the turbogenerator by regulating an amount of fluid flow bypassing an inlet of the turbogenerator turbine.

6. A method according to claim 1 or 2, in which the step of controlling comprises controlling warming up of the turbogenerator by regulating an amount of fluid flow bypassing an inlet of the turbogenerator turbine.

7. A method according to claim 1, in which the turbogenerator is in a series configuration with the turbocharger, an exhaust conduit of the turbocharger turbine being connected to an inlet of the turbogenerator turbine, and in which the step of controlling comprises further controlling the air to fuel ratio of the air-fuel mixture for the reciprocating engine by controlling a pressure drop in fluid from the exhaust conduit of the turbocharger turbine across the at least one valve.

8. A method according to claim 1, in which the turbogenerator is in a series configuration with the turbocharger, an exhaust conduit of the turbocharger turbine being connected to an inlet of the turbogenerator turbine, and in which the step of controlling comprises controlling one of the pressure and the temperature in the exhaust conduit of the reciprocating engine by regulating an amount of fluid flow from the exhaust conduit of the turbocharger turbine bypassing the inlet of the turbogenerator turbine and/or modifying the turbogenerator speed.

9. A method according to claim 1, in which the turbogenerator is in a parallel configuration with the turbocharger, the exhaust conduit of the reciprocating engine being connected respectively to an inlet of the turbocharger turbine and by way of a branch line to an inlet of the turbogenerator turbine, and in which the step of controlling comprises controlling start-up of the reciprocating engine by controlling a pressure drop in fluid from the exhaust conduit of the reciprocating engine across the at least one valve and/or modifying the turbogenerator speed.

10. A method according to claim 1, in which the step of controlling comprises monitoring whether a waste gate valve connected in parallel with one or both of the turbocharger turbine and the turbogenerator turbine has opened up beyond a predetermined amount, and if so generating actuating signals for controlling the at least one valve to regulate fluid flow to the turbogenerator turbine.

11. A method according to claim 1, in which the step of controlling comprises initiating valve control when a waste gate valve connected in parallel with one or both of the turbocharger turbine and the turbogenerator turbine has been opened to at least a first predetermined amount.

12. A method according to claim 11, in which the step of controlling comprises the step of ramping the turbogenerator turbine up to running speed and holding the valve positions for the at least one valve.

13. A method according to claim 12, in which the step of controlling comprises the step of initiating feedback signals to increase power if the power developed by the turbogenerator is below a minimum power requirement, and the step of returning to holding the valve position when the power again exceeds the minimum power requirement.

14. A method according to claim 13, in which the step of controlling comprises the step of reducing pressure when the waste gate valve is open greater than a second predetermined amount, and to hold the valve position when the waste gate decreases below the second predetermined amount.

15. A method according to claim 14, in which the step of controlling comprises the step of reducing power when the power developed by the turbogenerator exceeds the maximum power, and a step of returning to holding the valve position when the power has been reduced below the maximum power.

16. A method according to claim 1, in which the step of controlling comprises regulating the air to fuel ratio of the air-fuel mixture for the reciprocating engine to within a limited range by, if the air to fuel ratio is too low, opening a valve regulating an amount of fluid flow bypassing an inlet of the turbogenerator turbine and decreasing the turbogenerator speed, and if the air to fuel ratio is too high, closing the valve regulating the amount of fluid flow bypassing an inlet of the turbogenerator turbine and increasing the turbogenerator speed.

17. A method according to claim 1, in which the turbogenerator is in a parallel configuration with the turbocharger, the exhaust conduit of the reciprocating engine being connected respectively to an inlet of the turbocharger turbine and by way of a branch line to an inlet of the turbogenerator turbine, and in which the step of controlling comprises, if the air to fuel ratio is too low, closing a waste gate valve connected in parallel with the turbocharger turbine and increasing the turbogenerator speed, and if the air to fuel ratio is too high, opening the waste gate valve and reducing the turbogenerator speed.

18. A system for recovering exhaust energy from exhaust fluid in an exhaust conduit of a reciprocating engine, comprising:
a turbocharger having a turbocharger turbine arranged to be driven by the exhaust fluid, the turbocharger turbine having an inlet for receiving the exhaust fluid and an outlet for exhausting the exhaust fluid;
a turbogenerator having a turbogenerator turbine arranged to be driven by the exhaust fluid, the turbogenerator turbine having an inlet for receiving the exhaust fluid and an outlet for exhausting the exhaust fluid;
an alternator arranged on an output shaft of the turbogenerator turbine for the conversion of shaft power into electrical power, and
a control arrangement for controlling operation of the turbogenerator turbine in dependence upon operating conditions within the system, the control arrangement including at least one valve for regulating fluid flow to the turbogenerator turbine.

19. A system according to claim 18 in which the turbogenerator is in one of a series configuration and a parallel configuration with the turbocharger.

20. A system according to claim 18 or 19, in which the control arrangement comprises a valve permutation selected from the group comprising: a turbogenerator regulating valve, a turbogenerator isolating valve, a turbocharger waste-gate valve and an overall system waste-gate valve.

21. A system according to claim 18, in which the at least one valve comprises a bypass valve arranged for regulating an amount of fluid flow bypassing the inlet of the turbogenerator turbine.

22. A system according to claim 18, 19 or 21, in which the at least one valve comprises an isolating valve connected upstream of the inlet of the turbogenerator turbine for controlling fluid flow into the inlet of the turbogenerator turbine.

23. A system according to claim 18 or 19, in which the at least one valve comprises a three-way regulator valve connected upstream of the inlet of the turbogenerator turbine and arranged respectively for controlling fluid flow into the inlet of the turbogenerator turbine and for regulating an amount of fluid flow bypassing the inlet of the turbogenerator turbine.

24. A system according to claim 18, in which the turbogenerator is in a series configuration with the turbocharger, an exhaust conduit of the turbocharger turbine being connected to the inlet of the turbogenerator turbine, and in which the at least one valve comprises a turbocharger waste-gate valve connected in a branch line between the exhaust conduit of the reciprocating engine and the exhaust conduit of the turbocharger turbine.

25. A system according to claim 18, in which the turbogenerator is in a parallel configuration with the turbocharger, the exhaust conduit of the reciprocating engine being connected respectively to the inlet of the turbocharger turbine and by way of a branch line to the inlet of the turbogenerator turbine, and in which the at least one valve comprises a turbocharger waste-gate throttle valve connected in the branch line.

26. A system according to any of claims 18 to 25, in which the at least one valve is one of manual and automatic, and in which the at least one valve is one of an on/off valve and a modulating valve.

27. A system for extracting energy from a fluid stream, comprising:
a turbogenerator having a turbogenerator turbine arranged to be driven by the fluid, the turbogenerator turbine having an inlet for receiving the fluid and an outlet for exhausting the fluid;
an alternator arranged on an output shaft of the turbogenerator turbine for the conversion of shaft power into electrical power; and
a control arrangement for controlling operation of the turbogenerator turbine in dependence upon operating conditions within the system, the control arrangement including at least one valve for regulating fluid flow to the turbogenerator turbine.

28. A method for extracting energy from a fluid stream, comprising driving a turbogenerator turbine of a turbogenerator by means of the fluid, employing an alternator arranged on an output shaft of the turbogenerator turbine for the conversion of shaft power into electrical power, and controlling operation of the turbogenerator turbine in dependence upon operating conditions within the system, the step of controlling including regulating fluid flow to the turbogenerator turbine by means of at least one valve.
